(19) United States
(12) Patent Application Publication
(10) Pub. No.: US 2024/0380600 A1
(43) Pub. Date: Nov. 14, 2024

(54) DRIVER ASSISTANCE SYSTEM COMPRISING A CENTRAL UNIT AND AT LEAST ONE CAMERA, AND CORRESPONDING IMAGE DATA TRANSMISSION METHOD

(71) Applicant: STMicroelectronics International N.V., Geneva (CH)

(72) Inventor: Laurent TABARIES, AUBAGNE (FR)

(21) Appl. No.: 18/659,856

(22) Filed: May 9, 2024

(30) Foreign Application Priority Data
May 9, 2023 (FR) 2304587

(51) Int. Cl. H04L 9/32; B60R 1/20; H04L 9/08; H04N 7/18

(52) U.S. Cl. CPC H04L 9/3228; B60R 1/20; H04L 9/0869; H04N 7/183; B60R 2300/30

(57) ABSTRACT

Driver assistance system comprising a control unit, at least one camera configured to transmit image data to the control unit, a first embedded secure element connected to the camera and a second embedded secure element connected to the control unit, wherein the first embedded secure element is configured jointly with the second embedded secure element to perform an authentication of the image data during a transmission of the image data from the camera to the control unit.

### CROSS REFERENCE TO RELATED APPLICATIONS

This application claims the priority benefit of French Patent Application No. 2304587, filed on May 9, 2023, entitled “Systeme D′aide A La Conduite Comprenant Une Unite Centrale Et Au Moins Une Camera, Et Procede De Transmission De Donnees D′image Correspondant”, which is hereby incorporated by reference in its entirety and to the maximum extent allowable by law.

### TECHNICAL FIELD

Implementations and embodiments relate to the securing of an Advanced Driver Assistance System (ADAS), particularly on images from cameras belonging to an ADAS.

### BACKGROUND

The advance driver assistance system is provided to make advanced or semi-advanced functions such as Adaptive Cruise Control (ACC) or Emergency Brake Assist (EBA) available to the driver of a vehicle.

The advanced driver assistance systems in the vehicle typically include an Automated Driving Control Unit (ADCU) as well as cameras inside and outside of the vehicle. The cameras may provide the control unit with images of the environment of the vehicle, including potential obstacles located along the path of the vehicle.

The images transmitted by the cameras are used to determine when the vehicle must brake or re-accelerate for example, and therefore must on the one hand reach the control unit within a relatively short time. On the other hand, the images transmitted by the cameras may have an influence on the driving of the vehicle, particularly on the actuation of the brakes and of the engine, which is critical in terms of risk and danger.

However, there is a risk of transmitting fraudulent images to the control unit, for example when the cameras are not reliable. This risk increases in the case of cameras located outside of the vehicle since these may be easily replaceable with other cameras belonging to malicious third parties.

Moreover, the use of increasingly efficient sensors in the cameras, further requires increasing resources in terms of energy and computing capacity, and that are therefore increasingly expensive.

Thus, there is a need to ensure trust in the images transmitted by the cameras, while preventing the saturation of the bandwidth required for transmitting the images, and furthermore advantageously limiting the cost and the consumption of energy.

### BRIEF SUMMARY

According to one aspect, a driver assistance system is proposed comprising a control unit, at least one camera configured to transmit image data to the control unit, a first embedded Secure Element (eSE) connected to the camera and a second embedded secure element connected to the control unit, wherein the first embedded secure element is configured jointly with the second embedded secure element to perform an authentication of the image data during a transmission of image data from the camera to the control unit.

For example, the first embedded secure element and the second embedded secure element are configured to authenticate the image data with one-time use secure data.

In other terms, in this embodiment, the two embedded secure elements may each be configured beforehand to contain a common list of one-time use “tokens” and these tokens may be stored in a secure memory (having a role of secure safe) of the two embedded secure elements.

Thus, in the system according to this aspect, the trust in the image transmitted by the camera is guaranteed thanks to a simplified authentication by embedded secure elements, placed for example end-to-end of said transmission, and that may be based on a one-time use mechanism of one-time use secure data, or “tokens”. For example, the tokens are stored in the memory of the embedded secure element. More particularly, the one-time use token mechanism does not need significant computing power and makes it possible to rapidly authenticate the images and is not restrictive in terms of bandwidth of the video stream.

The authentication of images by the embedded secure elements therefore makes it possible, apart from the fact of ensuring the trust in the image from the cameras, to avoid degrading the bandwidth regardless of the quality of the images transmitted by the camera(s).

In particular, the secure element may advantageously include hardware protection means adapted for a certification at least “EAL4+” or above (for example “EAL5+” or even “EAL6+”). The certification “EAL5+” (acronym for “Evaluation Assurance Level 5+”) for example is an evaluation assurance level 5 according to criteria typically defined in the ISO-15408 standards. The certification may be obtained for example by satisfying a class 5 advanced methodical vulnerability analysis “AVA VAN5” (standing for “Vulnerability Assessment” and “Vulnerability Analysis”) of said common criteria.

According to one embodiment, the first embedded secure element and the second embedded secure element each comprise a secure memory configured to store a seed key, and generation means configured to generate the one-time use secure data (that is to say the “tokens”) from the seed key.

The secure data may be generated, for example pseudo-randomly, from the seed key thanks to usual derivation algorithms. Furthermore, the memory of each embedded secure element makes it possible to reliably store the seed key in order to generate the secure data in the same way in the two embedded secure elements. This is particularly advantageous on the level of the memory space used, for example as opposed to a storage of a “raw” list of secure data.

According to one embodiment, the first embedded secure element is configured to mark said image data with said one-time use secure data and the second embedded secure element is configured to verify said image data marked with said one-time use secure data.

The first embedded secure element thus makes it possible to perform a specific marking of the images by combining the image data with the secure data, for example according to a technique of applying a watermark, so that the second embedded secure element can validate the images having this specific marking before transmitting them to the control unit.

Preferably, each item of secure data is used only once to mark an image and can no longer be re-used to mark other images. Equally preferably, the marking of the watermark (that is to say the marking with the secure data) is adapted so as not to deteriorate the content, that is to say not to prevent the use, of image data as an image.

According to one embodiment, the first embedded secure element and the second embedded element are configured to authenticate the image data by performing an “exclusive OR” Boolean operation between said image data and said one-time use secure data.

The “exclusive OR” Boolean operation is typically an operation that is quick and easy to execute, and adapted for the authentication of the watermark marking type.

According to another embodiment, the first embedded secure element is configured to encrypt said image data by using said one-time use secure data and the second embedded secure element is configured to decrypt said encrypted image data by using said one-time use secure data. With such methods as described herein, marking an image with a token is, among other things, fast because it is independent from the image itself. In contrast, conventional methods using tags needed to proceed to the hash of the image that is very expensive from resources point of view, and that is not the case here.

The embedded secure elements typically have encryption means that may advantageously be used for the authentication of images thanks to encryption algorithms, for example the block encryption such as the Advanced Encryption Standard (known by the person skilled in the art by the acronym “AES”). Such an encryption further makes it possible to reinforce the security of the system by making the data unintelligible during the transmission of images between the camera(s) and the control unit.

Moreover, when a plurality of images of the video stream comprise similar image data, for example the static elements of the environment of the vehicle, it is not necessary to encrypt all of the data of all of the images.

In this respect, according to one embodiment, the first embedded secure element is configured to encrypt at least one portion of the image data of an image selected from a set of images of a video stream.

The authenticated image is typically an image compressed by an inter-frame prediction algorithm that contains less image data than a raw image and therefore makes it possible for the embedded secure elements to encrypt and decrypt more rapidly.

According to another aspect, a method is proposed for transmitting image data from at least one camera to a control unit within a driver assistance system comprising an authentication of the image data with one-time use secure data by a first embedded secure element connected to the camera and a second embedded secure element connected to the control unit.

According to one implementation, the authentication of the image data is performed with one-time use secure data.

According to one implementation, the method comprises storing a seed key in a secure memory of the first embedded secure element and of the second embedded secure element and generating secure data from the seed key.

According to one implementation, the authentication of the image data comprises marking said image data with said one-time use secure data and verifying the image data marked with said one-time use secure data.

According to one implementation, the authentication comprises an “exclusive OR” Boolean operation between said image data and said one-time use secure data.

According to one implementation, the authentication comprises encrypting said image data with said one-time use secure data and decrypting the encrypted image data with said one-time use secure data.

According to one implementation, the encryption is performed on at least one portion of the image data of an image selected from a set of images of a video stream.

### BRIEF DESCRIPTION OF THE DRAWINGS

Other advantages and features of the present disclosure will become apparent upon examination of the detailed description of non-limiting embodiments and implementations, and the appended drawings, wherein:

FIG. 1 illustrates an example of advanced driver assistance system SYS; and

FIG. 2 illustrates embodiments and implementations of the present disclosure.

### DETAILED DESCRIPTION

The system SYS is typically installed in motor vehicles that benefit from driver assistance functions such as the adaptive cruise control for example. For this purpose, the system SYS includes a control unit ADCU and embedded sensors, particularly one or more cameras CAM, making it possible to transmit to the control unit ADCU information about the environment of the vehicle.

The Autonomous Driving Control Unit ADCU is an Electronic Control Unit ECU commonly used in the automotive field that is capable of managing a large amount of information. In particular, the control unit ADCU is configured to process information from various embedded sensors, for example to potentially activate the controls of the vehicle such as the steering, the braking or the start-up autonomously.

This information is in particular transmitted by the camera CAM that is located inside or outside of the vehicle. More particularly, the camera CAM is configured to transmit image data IMG_Data to the control unit ADCU. These image data IMG_Data typically correspond to binary image data (which may be coded in the form of a video stream of the MPEG type with I, P, B type image groups; images themselves coded in the form of a 4:4:2 or Ycr Ycb type matrix that thus make it possible to code the luminance and the chrominance of each pixel of the image). The images of this video stream may make it possible to identify the various elements of the environment of the vehicle in the field of vision of the camera CAM and to detect a potential obstacle in the path of the vehicle.

Nevertheless, the image data IMG_Data are likely to be fraudulent, particularly when the camera CAM itself has a fraudulent character if, for example, it is installed by a malicious individual, or if the video stream is intercepted by a malicious individual between the output from the camera and the arrival in the control unit ADCU in order to substitute the original stream with another stream that does not reflect the reality. Such image data IMG_Data, when their origin is not controlled, are unduly processed by the control unit ADCU and may consequently result in an inadequate response of the vehicle, for example in the event of erroneous detection of an obstacle identified from the image data IMG_Data. In any case, as they are accessible from the outside of the vehicle, the cameras may be a point of entry for a potential pirating of the system SYS. It is therefore proposed to limit the risk relating to this point of entry.

In this respect, the system SYS further includes a first embedded secure element ESE1 connected to the camera CAM and a second secured element ESE2 connected to the control unit ADCU. The first secure element ESE1 is configured jointly with the second embedded secure element ESE2 to perform an authentication of the image data IMG_Data during a transmission of the image data IMG_Data from the camera CAM to the control unit ADCU. For example, the image data IMG_Data may be transmitted end-to-end by means of the first secure element ESE1, for example integrated into the circuit of the camera CAM, and of the second secure element ESE2, for example integrated into the circuit of the control unit ADCU.

For example, the first embedded secure element ESE1 and the second embedded secure element are “secure” in that they include hardware protections such as active shield, environmental parameter monitoring, protection against fault injection, protection against lateral channel attack means, or other means. More generally, the embedded secure elements include hardware protections capable of obtaining an “EAL4+” or “EAL5+” (acronym for “Evaluation Assurance Level 4+/5+”) common criteria certification, that is to say an evaluation assurance level 4 or 5 according to common criteria, typically defined in the ISO-15408 standards. The certification may be obtained for example by satisfying 5 a class advanced methodical vulnerability analysis “AVA VAN5” (standing for “Vulnerability Assessment” and “Vulnerability Analysis”) of said common criteria.

Furthermore, the first embedded secure element ESE1 advantageously comprises a first memory MEM1 and the second embedded secure element ESE2 advantageously comprises a second memory MEM2. The first memory MEM1 and the second memory MEM2 are secure, and are configured to store one-time use secure data SEC_Data (that is to say the token), typically data of 128 bits, 192 bits or 256 bits, and are considered as “tamper-proof” (that is to say tamper-proof to the extent of the certification of secure elements). The risk of extracting or modifying secure data SEC_Data is consequently considered as almost zero.

Moreover, the first memory MEM1 and the second memory MEM2 are also configured to store a seed key SD Data. The first secure element ESE1 as well as the second secure element ESE2 comprise generation means, typically programs using a derivation algorithm that can be executed by a processor PROC, configured to generate the one-time use secure data SEC_Data from the seed key. The secure data SEC_Data are saved in the respective memories of the secure elements ESE1 and ESE2 and are particularly identical between the first memory MEM1 and the second memory MEM2. The secure data SEC_Data are not necessarily stored in the first memory MEM1 and the second memory MEM2 and may be stored in a different memory than that used to store the seed key SD Data, but in all cases, will be stored in the memory of the embedded secure element ESE1, ESE2.

The memory of each embedded secure element therefore makes it possible to reliably store a seed key to pseudo-randomly generate the secure data SEC_Data in the same way in the first secure element ESE and in the second secure element ESE2. Furthermore, the seed key has the advantage of being reusable and making it possible to generate new secure data SEC_Data once again as opposed to a raw storage of the secure data SEC_Data.

The secure data SEC_Data, once stored in the memories MEM1 and MEM2, make it possible for the secure elements ESE1 and ESE2 to authenticate an image (in raw or compressed format), that is to say the image data IMG_Data that are associated with it.

For this, the first secure element ESE1 comprises first authentication means STP1 for example capable of marking the image data IMG_Data of an image in raw or compressed format with the secure data SEC_Data. “Marking” means that the first authentication means STP1 are capable of combining the image data IMG_Data with the secure data SEC_Data, by applying a watermark to it for example, so as to produce marked image data STP_Data. Preferably, each item of secure data SEC_Data is used only once to mark an image and can no longer be re-used to mark other images. Equally preferably, the marking with the secure data SEC_Data is adapted so as not to deteriorate the content, that is to say not to prevent the use, of image data IMG_Data as an image. The first authentication means STP1 are, furthermore, capable of transmitting to the second secure element ESE2 the marked image data STP_Data.

The second secure element ESE2 comprises second authentication means STP2 capable of verifying the image data STP_Data marked with the secure data SEC_Data. The second authentication means STP2 may also transmit authenticated image data ATH_Data, that is to say the image data STP_Data considered as valid, to the control unit ADCU.

In the case of image data STP_Data considered as invalid by the second authentication means STP2, the second secure element ESE2 may be configured to transmit an error signal to the control unit ADCU that may then suspend the autonomous functions of the vehicle and display a warning message, on the instrument panel for example, intended for the driver in order to indicate to them the suspension of these autonomous functions.

Thus, the embedded secure elements ESE1 and ESE2 make it possible for the system SYS to benefit from a simple and rapid authentication based on a mechanism of using “tokens” corresponding to the one-time use secure data SEC_Data. The authentication based on such a mechanism guarantees the trust in the image from the camera CAM without needing significant computing power and without being restricted in terms of bandwidth of the video stream. For example, another approach that has been used, but which required demanding computing resources (e.g., bandwidth, computer power), is using tags that are hashes of unique images and that may be used as a signature for each image. In contrast, various embodiments of the present disclosure may use one-time use secure data SEC_Data (e.g., tokens) that are independent from the image content and that do not require significant computer power.

The authentication of images by the embedded secure elements ESE1 and ESE2 therefore makes it possible, apart from the fact of ensuring that the camera CAM is reliable (usually, the neologism “trustable” may be used), to avoid degrading the bandwidth, regardless of the quality of the images transmitted by the camera CAM. This authentication and the advantages that it provides are of course valid for using a plurality of cameras CAM.

A relatively simple and effective way in terms of execution speed for performing the marking of image data IMG_Data is the use of the “exclusive OR” Boolean operation. Indeed, the first embedded secure element ESE1 is configured to perform a first “exclusive OR” Boolean operation between the image data IMG_Data and the secure data SEC_Data and transmit the image data from this first operation STP_Data to the second embedded secure element ESE2. The second secure element ESE2 is configured to perform a second “exclusive OR” Boolean operation between the image data STP_Data from the first operation with the secure data SEC_Data and transmit to the control unit ADCU the authenticated image data ATH_Data from this second operation.

The first Boolean operation may be executed by the first authentication means STP1 and the second Boolean operation may be executed by the second authentication means STP2.

Alternatively, the authentication may provide for using an end-to-end encryption additionally making it possible for the system SYS to be protected against attempts to monitor or falsify the image data IMG_Data during their transmission, for example in the context of reverse engineering.

To this end, the first embedded secure element ESE1 is configured to encrypt the image data IMG_Data by using the one-time use secure data SEC_Data. The second embedded secure element ESE2 is configured to decrypt the encrypted image data STP_Data by using the one-time use secure data SEC_Data. In various embodiments, each symmetric ESE may contain a list of tokens that are the same and that start from a symmetric seed and derivation method. Using the lists, the first embedded secure element ESE1 may, for example, add a token to an image (e.g., as a watermark) and, when received, the second embedded secure element ELE2 may verify the received image with a respective token from the list of the second embedded secure element ESE2.

The embedded secure elements ESE1 and ESE2 typically have encryption means that may advantageously be used for the authentication of images thanks to encryption algorithms, for example the block encryption such as the Advanced Encryption Standard (known by the person skilled in the art by the acronym “AES”). It will be noted that the “AES” technique is particularly relevant in this context because the two embedded secure elements may use a symmetrical encryption means on the basis of a secret key that will also be provided (that is to say “saved”) upstream in each embedded secure element. Such an encryption further makes it possible to reinforce the security of the system by making the data unintelligible during the transmission of images between the camera CAM and the control unit ADCU.

Moreover, when images of the video stream comprise similar image data, for example the static elements of the environment of the vehicle, it is not necessary to encrypt all of the data of all of the images.

In this respect, the first embedded secure element ESE1 is configured to encrypt at least one portion of the image data IMG_Data of a predicted image from a usual inter-frame prediction algorithm.

Indeed, the camera CAM (or the first secure element ESE1) comprises video compression means adapted to determine an image of the “inter-frame” type belonging to the video stream that has been coded from the inter-frame prediction algorithm. This inter-frame prediction algorithm makes it possible to define a movement vector that translates the displacement of a block into an already so-called reference coded image of a group of pictures (better known under the acronym “GOP”) and its position in the current image. The group of images is typically a structure consisting of predictive images (referred to as P-frames), bi-directional images (referred to as “B-frames”) as well as intra images (referred to as “I-frames”) particularly making it possible to code the information of the movement vector.

The image data IMG_Data associated with the moving block on one or more images of the coded stream may then be determined and predicted from a reference image and from the movement vector of the block computed by the prediction algorithm.

Consequently, the first secure element ESE1 no longer needs to encrypt all of the image data of an image and it is therefore sufficient to only encrypt the predicted image data IMG_Data by not taking into account data identified by the algorithm as redundant (that is to say macroblock data for which the movement vector is substantially zero).

Advantageously, the prediction algorithm is based on a reference image selected on a stream of 24 images per second. That said, the reference image may be updated over a shorter period in order to reduce the error margins of the prediction algorithm.

Thus, the use of such an algorithm by the first secure element ESE1 makes it possible to save considerable time for the authentication of image data IMG_Data since only the most important image data, that is to say those associated with a moving object are encrypted and decrypted by the embedded secure elements at regular time intervals.

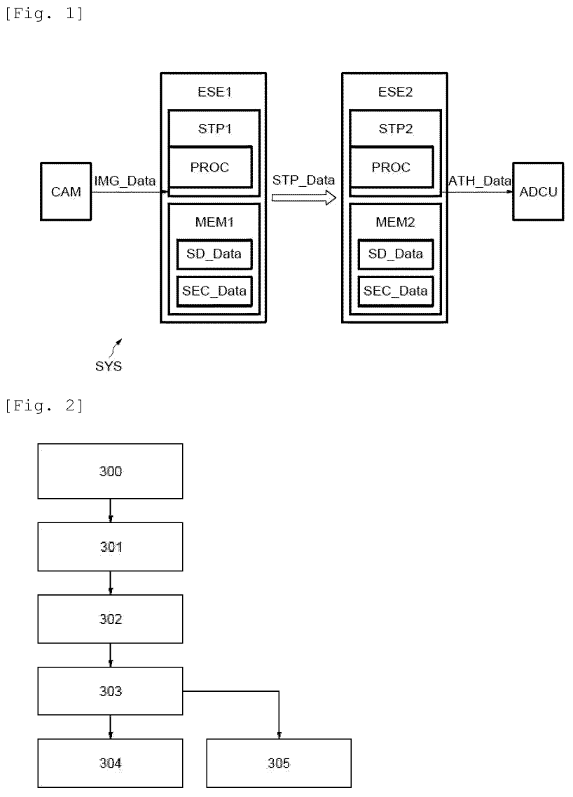

FIG. 2 illustrates a method for transmitting image data IMG_Data implemented by the driver assistance system SYS described above in relation with FIG. 1.

The method comprises a step of initialising 300 the first embedded secure element ESE1 and the second embedded secure element ESE2. The initialisation step 300 comprises generating secure data SEC_Data from a seed key stored beforehand in the first memory MEM1 of the first secure element ESE1 and in the second memory MEM2 of the second secure element ESE2. Each of the first embedded secure element ESE 1 and the second embedded secure element ESE 2 may contain a list of tokens that are the same and that start from a symmetric seed and derivation method. These lists may, for example, contain a large number of tokens (e.g., billions of tokens) to use one token per image. Additionally, each ESE may also be configured to regenerate tokens and/or the list of tokens locally inside the respective ESE, which may be performed in a safe and secure way.

The method comprises a step 301 of generating image data IMG_Data by the camera CAM. In particular, the image data IMG_Data may correspond to the data of a full raw image, before compression, of the “Raw Image” type or of a compressed image, for example according to an inter-frame prediction algorithm.

A step 302 of marking image data IMG_Data is performed by the authentication means STP1 of the first secure element ESE1 with the secure data SEC_Data and makes it possible to obtain marked image data STP_Data.

In particular, the step 302 of marking comprises an “exclusive OR” Boolean operation between the image data IMG_Data and the secure data SEC_Data.

Alternatively, the step 302 is an encryption step performed by the first secure element ESE1 with the secure data.

A step 303 of verifying the image data is performed by the authentication means STP2 of the second secure element ESE2 with the secure data SEC_Data and makes it possible to obtain authenticated image data ATH_Data.

In particular, the verification step 303 comprises an “exclusive OR” Boolean operation between the marked image data STP_Data and the secure data SEC_Data.

Alternatively, the step 303 is a decryption step performed by the second secure element ESE2 with the secure data.

Although the image data ATH_Data are validated by the second secure element ESE2 at the end of step 303, a step 304 of receiving and processing by the control unit ADCU is performed in order to or not to activate the autonomous function depending on the information contained in the image data IMG_Data.

In the opposite case, a warning step 305 is performed and comprises in particular transmitting a warning message to the driver of the vehicle in order to indicate to them the suspension of the autonomous functions.

What is claimed is:

1. A driver assistance system comprising a control unit, at least one camera configured to transmit image data to the control unit, a first embedded secure element connected to the camera and a second embedded secure element connected to the control unit, wherein the first embedded secure element is configured jointly with the second embedded secure element to perform an authentication of the image data during a transmission of the image data from the camera to the control unit.

2. The system according to claim 1, wherein the first embedded secure element and the second embedded secure element are configured to authenticate the image data with one-time use secure data.

3. The system according to claim 2, wherein the first embedded secure element and the second embedded secure element each comprise a secure memory configured to store a seed key, and generation means configured to generate the one-time use secure data from the seed key.

4. The system according to claim 2, wherein the first embedded secure element is configured to mark the image data with the one-time use secure data and the second embedded secure element is configured to verify the image data marked with the one-time use secure data.

5. The system according to claim 3, wherein the first embedded secure element is configured to mark the image data with the one-time use secure data and the second embedded secure element is configured to verify the image data marked with the one-time use secure data.

6. The system according to claim 4, wherein the first embedded secure element and the second secure embedded element are configured to authenticate the image data by performing an exclusive OR Boolean operation between the image data and the one-time use secure data.

7. The system according to claim 2, wherein the first embedded secure element is configured to encrypt the image data by using the one-time use secure data and the second embedded secure element is configured to decrypt the image data encrypted by using the one-time use secure data.

8. The system according to claim 3, wherein the first embedded secure element is configured to encrypt the image data by using the one-time use secure data and the second embedded secure element is configured to decrypt the image data encrypted by using the one-time use secure data.

9. The system according to claim 7, wherein the first embedded secure element is configured to encrypt at least one portion of the image data of an image selected from a set of images of a video stream.

10. The system according to claim 8, wherein the first embedded secure element is configured to encrypt at least one portion of the image data of an image selected from a set of images of a video stream.

11. A method for transmitting image data from at least one camera to a control unit within a driver assistance system comprising an authentication of the image data with one-time use secure data by a first embedded secure element connected to the camera and a second embedded secure element connected to the control unit.

12. The method according to claim 11, wherein the authentication of image data is performed with one-time use secure data.

13. The method according to claim 12, comprising storing a seed key in a secure memory of the first embedded secure element and of the second embedded secure element and generating secure data from the seed key.

14. The method according to claim 12, wherein the authentication of the image data comprises marking the image data with the one-time use secure data and verifying the image data marked with the one-time use secure data.

15. The method according to claim 13, wherein the authentication of the image data comprises marking the image data with the one-time use secure data and verifying the image data marked with the one-time use secure data.

16. The method according to claim 13, wherein the authentication comprises an exclusive OR Boolean operation between the image data and the one-time use secure data.

17. The method according to claim 12, wherein the authentication comprises encrypting the image data with the one-time use secure data and decrypting the image data encrypted with the one-time use secure data.

18. The method according to claim 13, wherein the authentication comprises encrypting the image data with the one-time use secure data and decrypting the image data encrypted with the one-time use secure data.

19. The method according to claim 17, wherein encryption is performed on at least one portion of the image data of an image selected from a set of images of a video stream.

20. The method according to claim 18, wherein encryption is performed on at least one portion of the image data of an image selected from a set of images of a video stream.
